(19) United States
(12) Patent Application Publication
(10) Pub. No.: US 2008/0055165 A1
(43) Pub. Date: Mar. 6, 2008

(54) Antenna device for portable terminal

(75) Inventors: Joung-Sub Shin, Yongin-si (KR); Yong-Jin Kim, Seoul (KR); Jae-Ho Lee, Yongin-si (KR); Young-Hwan Kim, Dalseo-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/709,826

(22) Filed: Feb. 23, 2007

(30) Foreign Application Priority Data
Sep. 4, 2006 (KR) 84665/2006

(51) Int. Cl. H01Q 1/24

(52) U.S. Cl. 343/702

(57) ABSTRACT

An antenna device for a portable terminal. The antenna device includes a carrier mounted in a housing of the portable terminal, at least one support extending from the carrier, a main radiator attached onto the carrier and an auxiliary radiator extending from the main radiator and fixed to ends of the supports while being spaced apart from the carrier. Since the antenna device includes the supports extending from the carrier to support the auxiliary radiator extending from the main radiator, the auxiliary radiator can be spaced apart from the carrier and the inner side of the housing of the portable terminal when the antenna device is mounted in the portable terminal. Thus, by reducing interference from a user's body or structures in the housing of the portable terminal, stable radiation performance can be secured. Moreover, the shape of the carrier can be easily changed suitably for a slim portable terminal by supporting the auxiliary support using the supports, whereby the antenna device can be easily installed in a small mounting space in a compact and slim portable terminal and an effective area of the antenna device can be minimized and an antenna gain can be improved in the same size space.

### CROSS-REFERENCE TO RELATED PATENT APPLICATIONS

This application claims the benefit under 35 U.S.C. § 119(a) of Korean Patent Application Serial No. 2006-84665, filed on Sep. 4, 2006, in the Korean Intellectual Property Office, the entire disclosure of which is hereby incorporated by reference.

### BACKGROUND OF THE INVENTION

1. Field of the Invention

The present invention relates to a portable terminal. More particularly, the present invention relates to an embedded type antenna device accommodated in a housing of a portable terminal.

2. Description of the Related Art

A portable terminal refers to an apparatus for providing a mobile communication function to a user. Recently, the portable terminal is used as not only a simple mobile communication apparatus but also a multi-function apparatus that provides multimedia services such as reproduction of music files and moving picture files and financial services such as retail payment and mobile banking.

A portable terminal may include a keypad and/or a microphone device as an input device for inputting character and/or voice information. A portable terminal may further include a display device and/or a speaker device as output device(s) for outputting stored information, received information and/or voice information. The portable terminal may further include a communication circuit and antenna devices for communication between common carriers, base stations and users.

The antenna devices of the portable terminal are classified into either externally mounted type antennas or embedded type antennas, according to the way they are mounted. The externally mounted type antennas include removable type antennas for receiving Digital Multimedia Broadcasting (DMB).

The externally mounted type antenna is mounted on a housing of the portable terminal, protrudes to the outside and can be drawn out if necessary by the user. Since a user can selectively draw the externally mounted type antenna according to a radio environment, superior transmission/reception performance can be achieved. However, the externally mounted type antenna may be an obstacle to the design of the portable terminal and may be damaged by an external shock such as dropping because it protrudes to the outside of the portable terminal.

The embedded type antenna is installed in the portable terminal and thus does not have an influence upon the appearance of the portable terminal, which is advantageous in diversification of the design of the portable terminal. However, if an antenna pattern is directly attached to the inside of the portable terminal, it is difficult to feed the antenna pattern and the antenna performance may not be properly implemented due to an influence from a user's body.

Accordingly, there is a need for an improved antenna device for portable terminals that is embedded in the portable terminals but does not diminish antenna performance.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an antenna device wherein an antenna pattern is mounted in the housing of the portable terminal after being attached to a separate carrier instead of being directly attached to the housing of the portable terminal, which can overcome the difficulty of securing a space for mounting the antenna due to interference between the carrier and the housing.

An aspect of exemplary embodiments of the present invention also provides an antenna device for a portable terminal which can be easily mounted in a small mounting space.

An aspect of exemplary embodiments of the present invention also provides an antenna device for a portable terminal which suppresses an influence from a user's body and implements superior performance.

An aspect of exemplary embodiments of the present invention also provides an antenna device for a portable terminal where the antenna device includes a carrier mounted in a housing of the portable terminal, at least one support extending from the carrier, a main radiator attached onto the carrier and an auxiliary radiator extending from the main radiator and fixed to ends of the supports while being spaced apart from the carrier.

### BRIEF DESCRIPTION OF THE DRAWINGS

The above and other exemplary objects, features and advantages of certain exemplary embodiments of the present invention will become more apparent from the following detailed description taken in conjunction with the accompanying drawings in which:

FIG. 1 is a perspective view of a portable terminal including antenna device according to a an exemplary embodiment of the present invention;

FIG. 2 is a perspective view of an antenna device mounted in a portable terminal shown in FIG. 1; and

FIG. 3 is a perspective view showing a state where an antenna device shown in FIG. 2 is mounted in a housing of a portable terminal.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

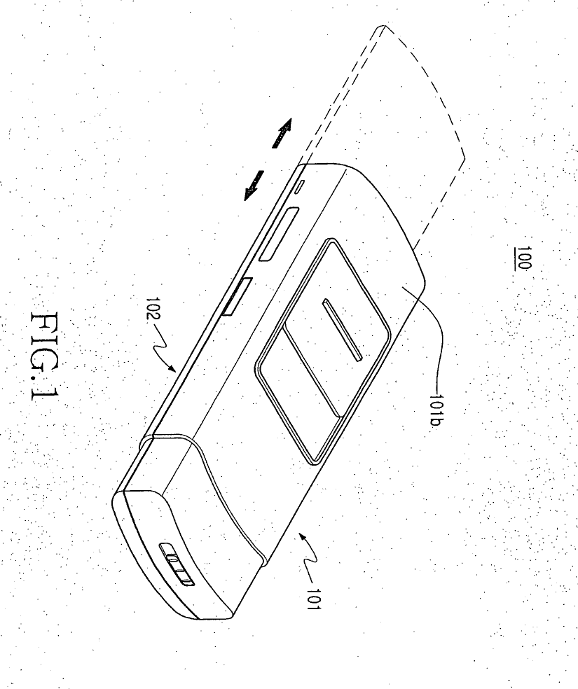

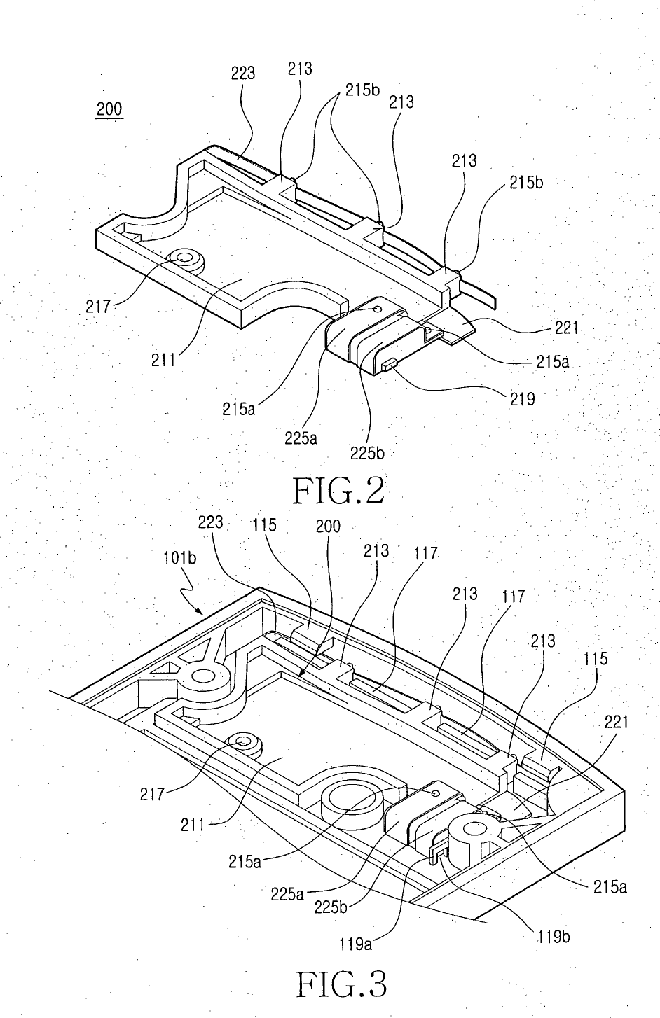

As shown in FIGS. 1 and 2, according to an exemplary embodiment of the present invention, a portable terminal 100 including an antenna device 200 according includes a first housing 101 and a second housing 102 that is slidably coupled to the first housing 101. As the second housing 102 slides on the first housing 101, a portion of the first housing 101 is opened or closed.

Although not shown in the figures, a keypad and a transmitting unit (or a mouthpiece) are installed on the front face of the first housing 101 and a display device, a receiving unit (or an earpiece) and a functional keypad are installed on the front face of the second housing 102. As the second housing 102 slides, the keypad and the transmitting unit are opened or closed.

Referring to FIGS. 2 and 3, the antenna device 200 includes a carrier 211 and radiators 221 and 223 installed in the first housing 101 through the carrier 211.

The carrier 211 is installed in a back case 101b of the first housing 101 as having the radiators 221 and 223 attached thereto. The carrier 211 includes at least one support 213 extending to the outside from the outer circumferential face of a side of the carrier 211. In an exemplary embodiment of the present invention, the carrier 211 has three supports 213. If the size of the carrier 211 increases, the number of supports 211 may also increase. In other words, the number of supports 213 is adjusted according to the size of the carrier 211 and the size of a mounting space in the back case 101b.

To mount the carrier 211 in the first housing 101 into the back case 101b, the carrier 211 includes at least one screw holes 217 and a fixing protrusion 219. A fixing rib 119b extending from the inner side of the back case 101b and facing the fixing protrusion 219 is further formed in the back case 101b. A fixing hole 119b corresponding to the fixing protrusion 219 is formed in the fixing rib 119a. Supporting ribs 117 extending from the inner side of the back case 101b and surrounding the carrier 211 are formed in the back case 101b. The supporting ribs 117 are positioned between the supports 213 while surrounding the outer circumferential face of the carrier 211.

Thus, once the carrier 211 is mounted in the back case 101b in a state where the fixing protrusion 219 is engaged in the fixing hole 119b, the supporting ribs 117 surround the outer circumferential face of the carrier 211. At this time, by engaging a screw through the screw hole 217, the carrier 211 is completely fixed into the back case 101b.

The radiators 221 and 223 include a main radiator 221 attached to one face of the carrier 211 and an auxiliary radiator 223 extending from the main radiator 221. The main radiator 221 is attached to the outer side of the carrier 211 and when the carrier 211 is mounted in the back case 101b, the main radiator 221 faces the inner side of the back case 101b.

At least one connection terminals 225a and 225b for connecting the radiators 221 and 223 to circuit devices of the portable terminal extend from the main radiator 221. In an exemplary embodiment of the present invention, a pair of connection terminals extend from the main radiator 221 to surround the outer circumferential face of the carrier 211 and their ends are positioned in the inner side of the carrier 211. One of the connection terminals 225a and 225b may be a feeding terminal and the other may be a ground terminal.

The auxiliary radiator 223 extends to surround a portion of the outer circumferential face of the carrier 211 as being spaced apart from the outer circumferential face of the carrier 211 and is adhered closely to and fixed to ends of the supports 213 at predetermined intervals.

To fix the main radiator 221, the auxiliary radiator 223 and the connection terminals 225a and 225b are fixed onto the carrier 211 or the supports 213 where the antenna device 200 includes welding protrusions 215a and 215b.

To fix the auxiliary radiator 223, the welding protrusions 215b are formed at ends of the supports 213 and are combined with and penetrate the auxiliary radiator 223. If the welding protrusions 215b penetrate the auxiliary radiator 223 and their ends are heated and welded, the lengths of the welding protrusions 215b decrease while the diameters of the welding protrusions 215b increase, thereby fixing the auxiliary radiator 223 to the ends of the supports 213. As the auxiliary radiator 223 is adhered closely to and fixed to the ends of the supports 213, it keeps being spaced apart from the outer side of the carrier 211.

Similarly, other welding protrusions 215a are formed in the carrier 211 and are combined with and penetrate the connection terminals 225a and 225b. By heating and welding ends of the welding protrusions 215a that protrude after penetrating the connection terminals 225a and 225b, the connection terminals 225a and 225b are adhered closely to and fixed to the inner side of the carrier 211.

Although not shown in figures, a plurality of welding protrusions are formed in the outer side of the carrier 211 and are combined with and penetrate the main radiator 221. By heating and welding ends of the welding protrusions, the main radiator 221 is adhered closely to and fixed to the outer side of the carrier 211.

If the carrier 211 is mounted in the inner side of the back case 101b after the radiators 221 and 223 and the connection terminals 225a and 225b are fixed onto the carrier 211, the main radiator 221 faces the inner side of the back case 101b and the auxiliary radiator 223 faces the inner wall of the back case 101b. At this time, the supporting ribs 117 surround the outer side of the carrier 211 and the auxiliary radiator 223 is positioned between the supporting ribs 117 and the inner wall of the back case 101b.

In the inner wall of the back case 101b, at least one of the auxiliary supports 115 is formed to support the auxiliary radiator 223 while surrounding a portion of the edge of the auxiliary radiator 223. As the auxiliary supports 115 are formed, the auxiliary radiator 223 can be stably positioned between the outer circumferential face of the carrier 211 and the inner wall of the back case 101b. Moreover, since the auxiliary radiator 223 can keep from being spaced apart the first housing 101 and face the first housing 101 of the portable terminal 100, the inner wall of the back case 101b can stably perform transmission and reception operations without being affected by a user's body.

As described above, the antenna device for the portable terminal includes the supports extending from the carrier to support the auxiliary radiator extending from the main radiator, whereby the auxiliary radiator can be spaced apart from the carrier and the inner side of the housing of the portable terminal when the antenna device is mounted in the portable terminal. Thus, by reducing interference from a user's body or structures in the housing of the portable terminal, stable radiation performance can be secured. Moreover, since the shape of the carrier can be easily changed suitably for a slim portable terminal by supporting the auxiliary support using the supports, the antenna device can be easily installed in a small mounting space in a compact and slim portable terminal and an effective area of the antenna device can be minimized, thereby improving an antenna gain in the same size space. Furthermore, the connection terminals are positioned in the inner side of the carrier, thereby facilitating feeding and grounding.

While the present invention has been shown and described with reference to certain exemplary embodiments thereof, it will be understood by those skilled in the art that various changes in form and details may be made therein without departing from the spirit and scope of the invention as defined by the appended claims and their equivalents. For example, although the antenna device 200 is mounted in the back case of the first housing of the sliding-type portable terminal in an exemplary embodiment of the present invention, it may also be installed in the front case of the first housing or the second housing.

What is claimed is:

1. An antenna device for a portable terminal, comprising:
a carrier mounted in a housing of the portable terminal;
at least one support extending from the carrier;
a main radiator attached onto the carrier; and
an auxiliary radiator extending from the main radiator and fixed to ends of the supports while being spaced apart from the carrier.

2. The antenna device of claim 1, further comprising a welding protrusion protruding from the ends of the supports and penetrating the auxiliary radiator, wherein an end of the welding protrusion is heated and welded to adhere the auxiliary radiator closely to the ends of the supports.

3. The antenna device of claim 1, wherein the main radiator is attached to the outer side of the carrier to face the inner side of the housing of the portable terminal.

4. The antenna device of claim 1, further comprising at least one connection terminals extending from the main radiator, wherein ends of the connection terminals are positioned in the inner side of the carrier.

5. The antenna device of claim 4, further comprising a welding protrusion protruding from the inner side of the carrier and penetrating the connection terminals, wherein an end of the welding protrusion is heated and welded to adhere the connection terminals closely to the inner side of the carrier.

6. The antenna device of claim 4, wherein the connection terminals are paired and one of them serves as a feeding terminal and the other serves as a ground terminal.

7. The antenna device of claim 1, further comprising an auxiliary support protruding from the inner wall of the housing of the portable terminal, wherein when the carrier is mounted in the housing, the auxiliary support supports the auxiliary radiator while surrounding a portion of the edge of the auxiliary radiator.

8. The antenna device of claim 1, further comprising:
at least one fixing protrusions protruding from the outer circumferential face of the carrier;
a fixing rib extending from the inner side of the housing; and
a fixing hole formed in the fixing rib,
wherein when the carrier is mounted in the housing, the fixing protrusion is engaged in the fixing hole.

9. The antenna device of claim 1, wherein at least one pair of supports are formed as being spaced apart from each other.

10. The antenna device of claim 9, further comprising at least one supporting rib extending from the inner side of the housing, wherein when the carrier is mounted in the housing, the supporting rib(s) are positioned between the supports.

11. The antenna device of claim 10, wherein the auxiliary radiator is positioned between the supporting rib(s) and the inner wall of the housing.
